(19) United States
(12) Patent Application Publication
(10) Pub. No.: US 2004/0222937 A1
(43) Pub. Date: Nov. 11, 2004

(54) Dipole antenna element, in particular a dual polarized dipole antenna element

(76) Inventors: Maximilian Gottl, Frasdorf (DE); Robert Kinker, Rosenheim (DE)

Correspondence Address: NIXON & VANDERHYE, PC, 1100 N GLEBE ROAD, 8TH FLOOR, ARLINGTON, VA, 22201-4714, US

(21) Appl. No.: 10/431,592

(22) Filed: May 8, 2003

(51) Int. Cl. H01Q 21/26

(52) U.S. Cl. 343/797

(57) ABSTRACT

An improved dual-polarized antenna element arrangement is distinguished by the following features:

the half-dipole components (111a, 114b; 112a, 111b; 113a, 112b; 114a, 113b) which interact with each other and, from the electrical point of view, each form a dipole half (3′a, 3′b; 3″a, 3″b) are connected via an electrical connection or a transverse strut (200), to be precise offset with respect to their outer corner region (202) in the direction of the center of the antenna element arrangement.

The invention relates to a dipole antenna element according to the precharacterizing clause of Claim 1. A dipole antenna element which forms this generic type has been disclosed, for example, in WO 00/39894, or likewise in U.S. Pat. No. 6,313,809 B1. This is a dual-polarized antenna element arrangement having two or more dipoles which, in a plan view, are each arranged in the form of a dipole square, or at least similar to a dipole square. The antenna element arrangement which is in the form of a dipole square or the antenna element arrangement which is at least approximately a dipole square (in a plan view as seen from its exterior) is connected and fed such that, from the electrical point of view, the antenna element arrangement transmits and receives in two mutually perpendicular polarization planes, which run parallel to the two mutually perpendicular diagonals which are formed by the antenna element arrangement.

A dual-polarized antenna element arrangement such as this has been proven well in practice and has major advantages over previous antenna element arrangements.

The object of the present invention is to provide a further improved antenna element arrangement which has even better characteristics particularly in terms of a broad bandwidth.

The object is achieved according to the features specified in Claim 1 and/or in Claim 4. Advantageous refinements of the invention are specified in the dependent claims.

It must be regarded as more than surprising that it has been possible to considerably further improve the broad bandwidth of an antenna element arrangement of this generic type, by means of simple technical measures. Specifically, according to the invention, this can be achieved by each of the four dipole halves that are produced from the electrical point of view (from the antenna element arrangement which transmits and receives in the manner of a dipole cruciform from the electrical point of view) each has an electrically conductive transverse strut, which runs transversely and preferably at right angles to the electrical polarization plane. The antenna element arrangement which forms this generic type is thus distinguished in that each dipole half is formed by two mutually perpendicular, or at least approximately mutually perpendicular, half-dipole components. The half-dipole components may be conductively connected at their end. However, they may also be only mechanically fixed with respect to one another or to one another and may have an electrically conductive connection in a strut or in the form of a strut, which is located offset with respect to their end as mentioned above (and at which they may be, but need not be, fixed with respect to one another, as mentioned).

It has now been found that the measures explained above allow the broad bandwidth of an antenna to be considerably further improved.

In one preferred embodiment of the invention, this cross connection is in this case in the form of a transverse strut.

The extensions of the half-dipole components, which run at an angle and preferably at right angles to one another, may be as mentioned conductively or mechanically fixed to one another at their intersection point, which is also referred to in the following text as their outer corner point. Those ends of the two half-dipole components which are in each case on the inside with respect to this and which form the respective half-dipole are preferably used as connecting points, which are connected to one another by an electrical cable or an electrically conductive structure. In principle, the electrical cross connection may, however, also be arranged or electrically linked at some other point between the two respectively interacting half-dipole components. The electrical cross connection or transverse strut is preferably in the form of a straight transverse strut, which is located at right angles to the corresponding polarization plane. However, in a plan view, it may also be at least slightly convex or concave, or may be formed with other curved sections. It may likewise also be at least partially run other than in the plane in which the individual half-dipole components are located. In other words, the transverse strut may also run at a distance from this plane, somewhat above or below it, with the plane which has been mentioned above generally being that plane in which all the half-dipole components are arranged. This plane is normally parallel to the reflector plane.

The respectively interacting half-dipole components may be electrically firmly connected in the outer corner regions, or else may be only mechanically connected there via a nonconductive electrical connecting piece. The corner regions may likewise be open.

The cross connection or transverse strut that has been explained may, however, likewise be in the form of a flat element. In this case, an opening area preferably remains, which remains in the outer corner region, passes through the flat arrangement of the dipole half formed in this way, and is preferably larger than at least 20% of the total area of a respective dipole half. This opening area, which passes through the surface, opens in a separation space between the outer half-dipole components, which run towards one another, can also be interpreted as edge boundaries of the respective dipole half and, in this embodiment, are not electrically connected to one another in their outer corner region.

This results in an antenna structure essentially such as that claimed in the second independent Claim 4. In this embodiment, the dipole halves are formed from flat elements, with the boundary edges which point towards one another of two adjacent dipole halves which are each associated with a different polarization being arranged symmetrically, and in this case preferably running parallel to one another. In a plan view, the flat dipole halves in this case each have a square shape or a shape similar to a square, with the respective outer boundaries which are located on the outside and run towards one another in their outer corner regions ending at least at a short distance from one another and having a connection through the separation area formed in this way to an opening or aperture area which passes through the flat dipole half. This opening area should have at least 20% of the area of the dipole halves. Otherwise, the flat dipole halves may also have further openings, for example even being in the form of grids or meshes. The flat elements of the dipole halves thus carry out that function which, in the embodiment according to Claim 1, is carried out by the electrical cross connections or transverse struts mentioned there.

A dual-polarized antenna having flat antenna elements has in principle also been disclosed in U.S. Pat. No. 6,028,563. The dipole arms or dipole halves in this case are triangular, however, that is to say the dipole halves do not themselves have a square structure. Furthermore, the flat dipole halves which are known from the abovementioned prior art are not provided with apertures, either.

Further advantages, details and features of the invention will become evident in the following text from the exemplary embodiments which are illustrated by drawings, with reference being made to the entire disclosure content of WO 00/39894 and U.S. Pat. No. 6,313,809 B1, which is parallel to it, and being included in the content of this application. In the attached figures:

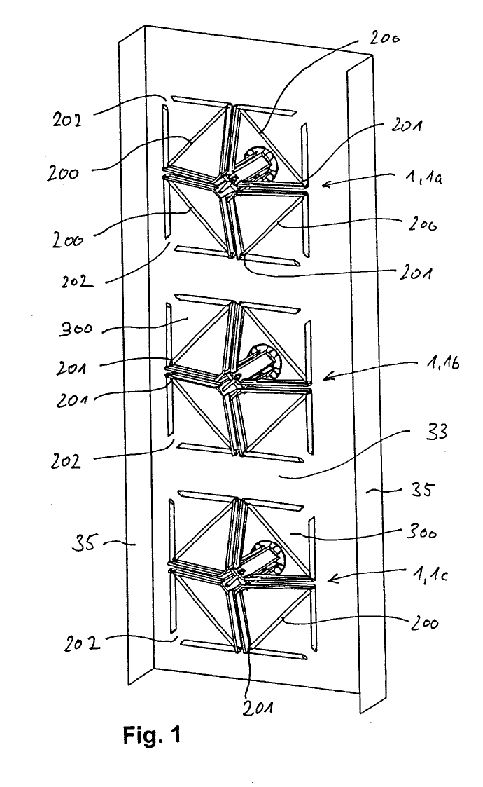

FIG. 1 shows a perspective illustration according to the invention of an antenna array having three dual-polarized antenna element arrangements according to the invention arranged vertically one above the other;

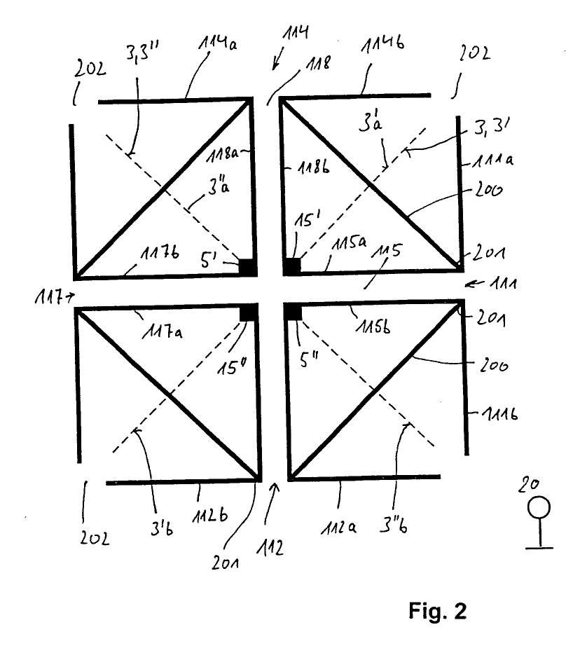

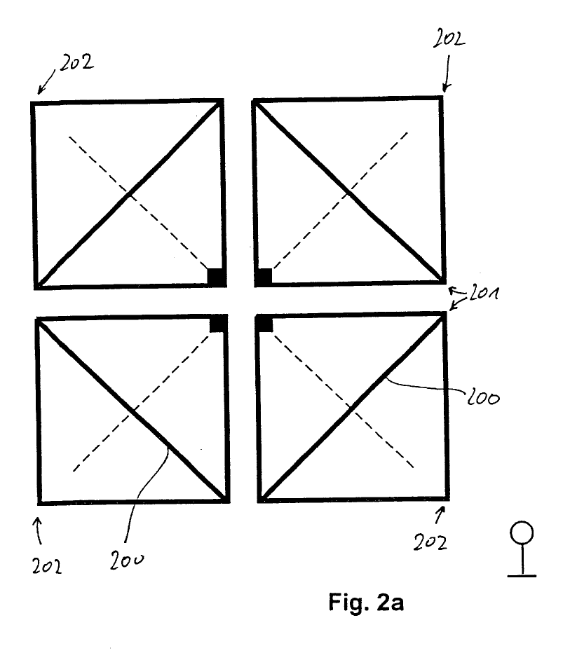

FIG. 2 shows a schematic plan view of a first exemplary embodiment of an antenna element arrangement according to the invention;

FIG. 2a shows an exemplary embodiment, modified from that in FIG. 2, corresponding to the plan view;

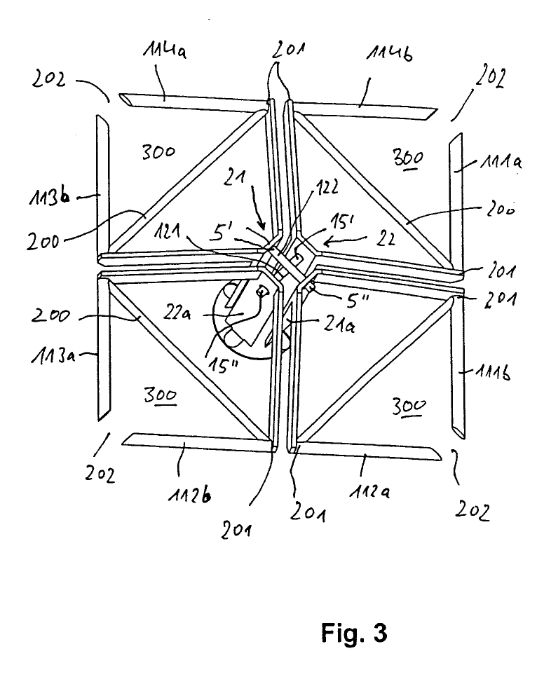

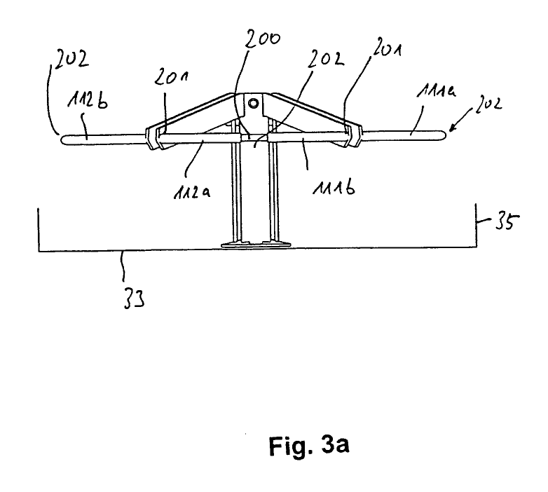

FIG. 3 shows a perspective illustration of a specifically shown exemplary embodiment of a dipole antenna element according to the invention;

FIG. 3a shows a schematic side view of the dual-polarized dipole antenna element according to the invention;

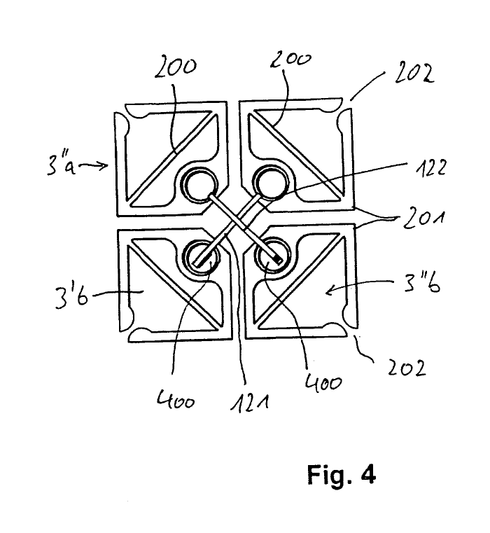

FIG. 4 shows a plan view of an antenna element arrangement, which has been slightly modified in comparison to the antenna element arrangements shown in the illustrations in FIG. 1, 2 or 3;

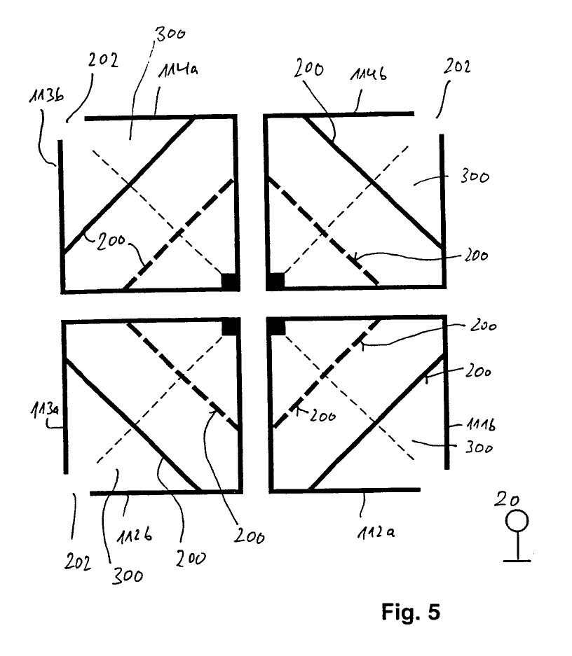

FIG. 5 shows a further exemplary embodiment, modified in comparison to FIG. 2;

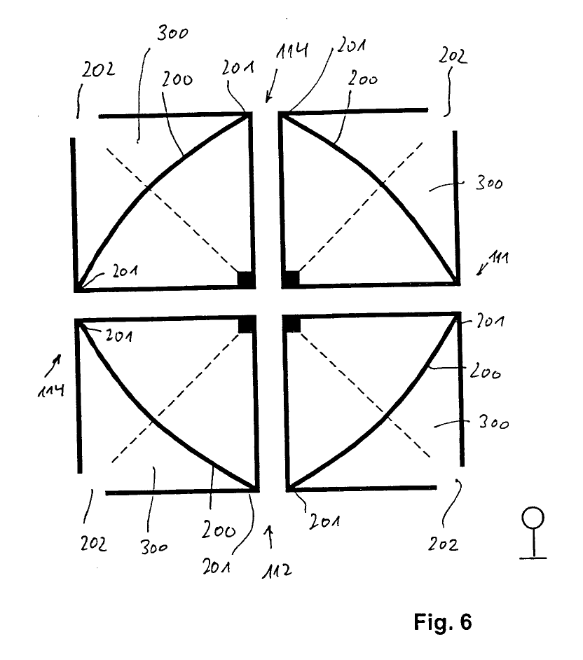

FIG. 6 shows a further exemplary embodiment, modified in comparison to FIG. 2 and FIG. 5;

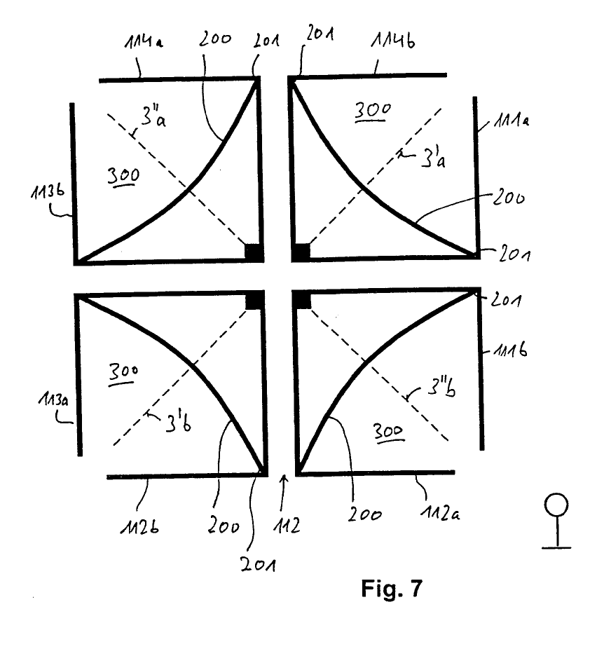

FIG. 7 shows a schematic plan view of a further modified exemplary embodiment;

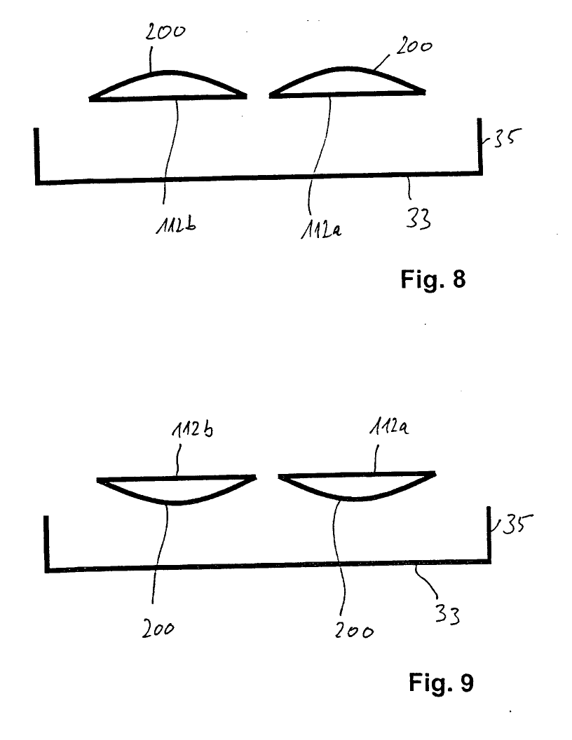

FIG. 8 shows a final further modified exemplary embodiment, in a view in the plane of the dipoles;

FIG. 9 shows an exemplary embodiment, slightly modified from that shown in FIG. 8, in a cross-sectional illustration transversely with respect to the reflector plane; and

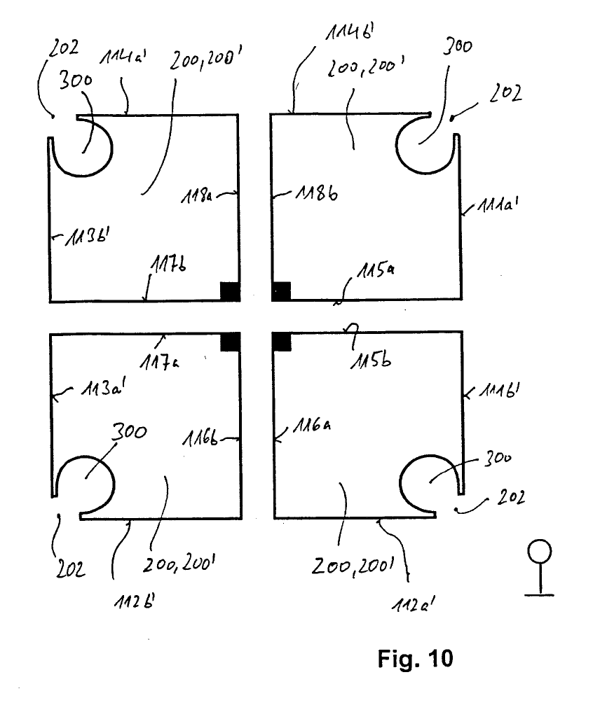

FIG. 10 shows a plan view of a modified exemplary embodiment with somewhat flat dipole halves.

FIG. 1 shows a schematic perspective plan view of an antenna array with three dual-polarized dipole antenna elements 1 arranged one above the other, with the dipole antenna element 1, in a plan view, being in the form of a dipole square, or similar to a dipole square. Although the half-dipole components which will be explained in more detail in the following text are aligned or appear aligned vertically or horizontally when the antenna array is aligned vertically, the dipole antenna elements which have been mentioned transmit and receive, from the electrical point of view, in an alignment of +45° and −45° with respect to the horizontal.

The three dipoles 1 which have been mentioned are arranged in front of a reflector plate 33, in the exemplary embodiment shown in FIG. 1. On its opposite side outer edges, the reflector plate is provided, for example, with electrically conductive edge sections 35 which run transversely with respect to the reflector plane, and preferably at right angles to the reflector plane.

FIG. 1 also shows that the dipole square may have a free section at the outer boundary corners 202, so that the half-dipole components, which will be explained in detail in the following text, end at a distance from one another and are not connected to one another there. This is shown for the uppermost antenna element arrangement 1a.

In contrast to this, the antenna element arrangements 1 could also be designed such that the half-dipole components are electrically conductively connected to one another in the corner regions 202, preferably in the form of a fixed mechanical connection.

The half-dipole halves could likewise be connected to one another only mechanically in the outer corner regions, that is to say by means of nonconductive attachments or inserts in the outer corner region. This outer corner region is thus defined by the two half-dipole components which belong to one electrical dipole half and intersect in their outer corner region, or at least whose extensions intersect in what is referred to as an outer corner region. The half-dipole components may end at a distance from one another in this corner region, so that their outer end regions do not touch this outer corner region. However, their outer end regions may also be mechanically connected to one another via a mechanical fixing, and may also be electrically connected to one another by an electrical connection.

In all three antenna element arrangements 1a to 1c, an electrical cross connection 200 is in each case formed, located offset inward from the corner regions and transversely with respect to the diagonal alignment of the transmission and reception or polarization planes, and this electrical cross connection 200 may preferably be in the form of an electrical transverse strut, which will likewise be described in more detail in the following text.

The dipole antenna element which is illustrated in the form of a schematic plan view in FIG. 2 and is illustrated in a somewhat more specific form in FIGS. 3 and 3a—and which will also be explained in detail in the following text—acts from the electrical point of view like a dipole which transmits and receives with a polarization of ±45°, that is to say by way of example like a cruciform dipole. The antenna element, which acts as a cruciform dipole 3 from the electrical point of view, is shown by dashed lines in FIG. 2. This antenna element, which from the electrical point of view acts as a cruciform dipole 3 and is aligned at ±45° with respect to the horizontal is formed by an electrical dipole 3′ (inclined in the +45° direction) and a dipole 3″ at right angles to it (inclined at −45° with respect to the horizontal). Each of the two dipoles 3′ and 3″ which are formed from the electrical point of view respectively comprises the associated dipole halves 3′a and 3′b for the dipole 3′, as well as the dipole halves 3″a and 3″b for the dipole 3″. From the physical design point of view, the electrically resultant dipole half 3′a is in this case formed by two mutually perpendicular half-dipole components 114b and 111a. In the illustrated exemplary embodiment, the half-dipole components 114b, 111a end with their ends (which run towards one another at right angles) at a distance from one another. They could, however, also be connected there, to be precise both by means of an electrically conductive metallic connection and by insertion of an electrically nonconductive element or insulator, in order, for example, to ensure better mechanical robustness. The dipole halves may also be provided with smaller angles at the end. As a supplement to FIG. 2, FIG. 2a therefore shows the outer corner region 202 of this antenna element arrangement being closed.

In a corresponding way, the next dipole half 3″b in the clockwise direction of the electrical dipole 3″ which is provided aligned at −45° from the electrical point of view is formed by the two half-dipole components 111b and 112a. The second dipole half 3′b, which is formed by the extension to the dipole half 3′a, is formed by the two half-dipole components 112b, 113a, and the fourth dipole half 3″a is formed by the two half-dipole components 113b, 114a, in an analogous manner.

As can be seen in the drawings, an electrical connection or transverse strut 200 is now provided or arranged with respect to each dipole half and, in the illustrated exemplary embodiment, is located transversely, that is to say in particular vertically, on the respective polarization plane 3′ or 3″. In this case, the strut 200 in each case connects two half-dipole components, namely the half-dipole components 114b and 111a, the half-dipole components 111b and 112a, the two half-dipole components 112b and 113a, and the half-dipole components 113b and 114a. This electrical connection or transverse strut 200 is in this case preferably arranged such that it assumes a maximum length, that is to say is preferably electrically and mechanically linked between the two diagonally opposite inner corner regions 201. These inner corner regions 201 are each formed by the end of the balanced lines 115 to 118, that is to say of the respectively associated line half 112a to 115b, and of the half-dipole components adjacent to them. In other words, these inner corner regions 201 are located opposite the outer corner region 202 in which two half-dipole components of one half-dipole each run towards one another, ending shortly in front of them, or being mechanically connected to one another via a mechanical fixing. The half-dipole components, which are arranged as a dipole square, are now each fed by a balanced feed line 115, 116, 117 and 118. In this case, by way of example, the two half-dipole components 114b and 111a, that is to say in each case the adjacent half-dipole components which are aligned at right angles to one another, are excited in phase via a common feed point, in this case the feed point 15′. The connecting cables which are associated with these half-dipole components 114b, 111a are each formed from two cable halves 118b and 115a which, when considered individually, represent an unbalanced line with respect to a fictional zero potential 20. In a corresponding way, for example, the two next half-dipole components 111b and 112a are electrically connected, etc. via the cable halves 115b and 116a, respectively, to their common feed point 5″. With this circuitry, the respectively associated balanced feed line is at the same time designed such that it provides the mechanical fixing for the dipoles, that is to say for the half-dipole components. In this case, by way of example, of the balanced line 115, the one unbalanced cable half 115a is fitted with the dipole half 111a, and the second cable half 115b, which is electrically isolated from the cable half 115a but preferably runs parallel to it, is fitted with the second dipole half 111b. Thus, in other words, the two associated unbalanced cable halves which belong to a balanced line 115 to 118 are in each case fitted with the two dipole halves, which are arranged as an axial extension with respect to one another, of a dipole 111 to 114. Since the cable halves which lead to the respectively adjacent mutually orthogonal dipole halves are electrically conductively connected at their feed point, this results in four interconnection points 15′, 5″, 15″, 5′ which are once again fed in a balanced manner, crossed over, as can also be seen in particular from the illustration in FIG. 5. The overall antenna element which results from this now acts electrically as a cruciform dipole by in-phase excitation of the half-dipole components 114b, 111a, of the half-dipole components 111b and 112a, and of 112b and 113a, as well as 113b and 114a. The specific arrangement of the cable halves which are each arranged parallel at a short distance apart from one another and through which the current flows in phase opposition ensures that the cable halves themselves do not produce any significant contribution to the radiation, that is to say with any radiation being cancelled out by overlapping.

FIG. 2 shows the basic structure in a plan view of the antenna element arrangement, with the antenna element module having quadruple symmetry in a plan view. Two mutually perpendicular axes of symmetry are formed by the balanced lines 115 and 117 as well as 112 and 118, with the third and fourth axes of symmetry being rotated through 45° with respect to this in a plan view of the antenna element arrangement as shown in FIG. 2, and being formed by the dipoles 3′ and 3″ that result from the electrical point of view.

In addition, FIG. 3 also shows in each case one part of the balancing device 21 at the feed and interconnection point 5′ and, a short distance away opposite the center point 5, the other part of the balancing device 21a, which on the one hand is used for mechanical attachment of the dipole structure to the reflector plate, and on the other hand allows the transition to unbalanced feed cables (for example coaxial cables) at the interconnection point.

In a corresponding manner, FIG. 3 in particular shows that the interconnection point 15′ for the half-dipole components 114b and 111a as well as the opposite interconnection point 15″ for the half-dipole components 112b and 113a are formed in the area of the balancing device 22 and, at 180° or opposite this, at the balancing device 22a which is likewise once again firstly used for mechanical attachment of the dipole structure to a rearward reflector plate 33, and on the other hand allows the transition to the unbalanced feed cable (or coaxial cable) at the interconnection point. In this case, FIG. 3 in particular shows very well how the electrical feed is provided via a cross-over circuit with a first circuit link 121 and a second circuit link 122, which is located offset through 90° with respect to this, at the respectively opposite balancing devices 21 and 21a, as well as 22 and 22a. The last-mentioned circuit links 121 and 122 are arranged at a vertical distance from one another, that is to say they are not electrically connected to one another.

In this case, FIG. 3 also shows that, by way of example, the link 122 which is in the form of a pin is mechanically firmly fitted to that half of the balancing device 22 which is located at the rear in FIG. 3, and is electrically connected there to the balancing device 22 while, in contrast, the opposite free end of this link, which is in the form of a pin, projects through a hole of appropriate size through the front half of the balancing device 22a, without needing to be electrically connected to this balancing device 22a. This makes it possible to route a coaxial cable for feed purposes in front of the balancing device 22a, to electrically link the outer conductor to the balancing device at some suitable point, to connect the inner conductor to the free end of the link 121, and to provide the feed in this way. The second part of the link 121 is also constructed in a corresponding manner, that is to say with its rearward end mechanically fitted to the balancing device 21 and electrically connected to it while, in contrast, the opposite free end projects through a larger hole without making electrical contact, beyond the balancing device 21a which is located at the front on the right in FIG. 3. There, the second coaxial cable can be laid, coming from underneath parallel to the balancing device, for example, with the outer conductor being electrically connected to the balancing device and with the inner conductor being connected to the free end of the link 121, which is in the form of a pin.

Merely for the sake of completeness, it should be mentioned that other connection options are likewise possible as well, for example in such a way that an inner conductor is passed from the bottom upwards between the respective balancing devices and is then electrically connected at some suitable point to the upper end of an associated balancing device in order to allow the symmetrical feed in this way. The outer conductor can also be routed over a part of this distance or else can be electrically connected at a lower level to the respectively opposite half of the balancing device. The possible implementations of the feed are to this extent explained only by way of example.

In other words, the feed is provided crossed-over between the feed points 5′ and 5″ and 15′, 15″. The electrical cable halves 115a to 118b which have been mentioned are in this case each arranged in pairs symmetrically with respect to one another, that is to say, the adjacent electrical cable halves of two adjacent half-dipole components in each case run parallel at a comparatively short distance apart from one another, with this distance preferably corresponding to the distance 55 between those ends which in each case point towards one another on the associated dipole halves, that is to say for example corresponding to the distance between those ends which point towards one another on the dipole halves 111a, 111b, etc. In principle, the cable halves may in this case run parallel to a rearward reflector plate in the plane of the half-dipole components. In contrast to this, the exemplary embodiment in FIGS. 2 and 3 shows an embodiment in which the cable halves, which also represent the holder device for the half-dipole components, are mounted such that they descend slightly starting from their associated balancing device and end at the same level as the half-dipole components, which can be arranged parallel to a rearward reflector plate 33. This depends on the waveband of the electromagnetic waves to be transmitted or received since the height of the balancing device above the reflector plate 33 should correspond approximately to λ/4 and, with regard to the radiation characteristic, it may possibly be desirable for the dipoles and dipole halves to be arranged closer to the reflector plate 33.

As a result of this arrangement, one dipole in this case always at the same time provides the +45° and the −45° polarization in which case, however, and in contrast to the physically geometric alignment of the individual half-dipole components in the horizontal and vertical directions, the resultant +45° polarization and −45° polarization are obtained only by the combination of the antenna element components, that is to say, in other words, the X-polarized cruciform dipole antenna element 3 which is shown, from the electrical point of view, in FIG. 2. The principle of the method of operation is that the currents on the supply lines or connecting lines which are in each case adjacent and are parallel to one another, are superimposed, that is to say for example the current on the electrical cable 115b being superimposed on the electrical cables 115a, and the current on the cable 116a having that on the electrical cable 116b superimposed on it, etc, with phase angles such that they do not also radiate, or also radiate only slightly, while, at the same time, the superimposition of the currents at the feed points means that the feed points (5′, 5″) are decoupled from the feed points (15′, 15″).

FIG. 1 shows how a dual-polarized dipole antenna element 1 as explained with reference to FIGS. 2 to 4 can also be used to form a corresponding antenna array with two or more dipole antenna elements 1 which are arranged, for example, one above the other in the vertical installation direction, and which overall describe an antenna with +45° and −45° polarization from the electrical point of view, despite the horizontally and vertically aligned half-dipole components.

The antenna element arrangements which are shown in FIG. 1 are each arranged with their associated balancing device on a reflector plate 33 which is provided, in the installation direction of the individual antenna element modules on the opposite sides, with electrically conductive edges 35 which run at right angles to the reflector plane.

However, in contrast to the described exemplary embodiments, it is equally possible not to provide the electrical feed to the dipole halves in the area of the balancing device and the cable halves which are electrically attached to the balancing devices 21, 21a and 22, 22a and which also carry out the holding function. In contrast to this, it is possible for the elements 115a to 118b, which are shown in FIGS. 2 to 5, to be in the form of nonconductive supporting elements for the dipole halves, and for the cables 115 to 118 to be routed directly from underneath through the reflector plate 33 to the connecting ends 215a, 215b, 216a, 216b, 217a, 217b and 218a, 218b. The important factor in this case is that a symmetrical or virtually symmetrical separation is achieved at the feed point of the dipole halves, and that the dipole halves are fed with the described phase angles with respect to one another. Furthermore, the feed lines may also run along or parallel to the wire elements. The preferred embodiment in this case is that in which the wire elements are at the same time electrically conductive and are used as feed lines. Finally, it is equally feasible for the supporting elements 115a to 118b for the dipole halves to be designed in a completely different manner from the physical point of view in a case such as this and to be arranged such that they run differently, for example from the connecting points 215a to 218b, starting from the center of the dipole halves or from the corner region of the respective mutually perpendicular dipole halves vertically or at an angle downwards to the reflector 33, where they are mechanically anchored.

Furthermore, in contrast to this, it is also feasible for the reflector itself to be in the form of a printed circuit board, that is to say by way of example to be in the form of the upper face of a printed circuit board on which the entire antenna arrangement is constructed. The corresponding feed can be provided on the rear face of the printed circuit board, with the electrical cable halves, starting from there, running on a suitable path to the connecting points 215a to 218b which have been mentioned. In order to achieve a radiation characteristic that is as good as possible, all that is necessary is to ensure that, irrespective of how they are routed to the connecting points at the dipole halves, these cable halves are as far as possible, that is to say essentially, or at least approximately aligned parallel to one another, in other words at least essentially or approximately resulting in a balanced line.

FIG. 4 shows a plan view of an antenna element arrangement which, in principle, is comparable to that antenna element arrangement which has been described with reference to FIG. 1, FIG. 2 and FIGS. 3 and 3a. The antenna element arrangement which is shown in the form of a plan view (that is to say at right angles to the reflector plane) in FIG. 4 has half-dipole components which end at a short distance from one another, without touching one another, in the outer corner regions 202. The half-dipole components may in this case be manufactured integrally. The transverse struts 200 which have been mentioned are an integral component of the respective dipole half. The plan view in FIG. 4 furthermore in this case shows the links 121 and 122, which are in the form of pins and are crossed over. The inner conductors of a coaxial cable for feeding the two polarizations can be passed up in channels or apertures 400 which run at right angles to the plane of the drawing or the reflector plane, with the outer conductor of the coaxial cable being formed directly by the metallic supporting structure, which is at the same time used for balancing, preferably at the upper end immediately in the connecting region while, in contrast, the inner conductor is electrically connected to the link 122 via which the opposite second dipole half 3″a is fed electrically. The structure itself in this case forms the outer conductor. The connection via a coaxial cable for the polarization that is located offset through 90° is likewise provided in such a way that the outer conductor of the coaxial cable is formed by the metallic structure itself in the other channel 400, and the outer conductor of the coaxial or feed cable is electrically connected at the upper end in the region of the dipole antenna elements to the associated dipole half 3b′ while, in contrast, the inner conductor is electrically connected to the link 121, which is electrically connected to the opposite dipole half 3′a via the other link 122, but without touching it.

As can be seen from the schematic plan view in FIG. 5, these electrical transverse struts 200, which electrically connect the two respectively interacting half-dipole components, may possibly also be arranged at a different point. In the exemplary embodiment shown in FIG. 5, these transverse struts 200 are arranged such that they are offset from their central position (as is shown in FIGS. 1 to 4) more towards their outer corner region 202. In this exemplary embodiment, however, they are still arranged transversely with respect to the respective polarization plane 3′ and 3″, that is to say at right angles to it. In some circumstances, the transverse struts 200 may also be arranged offset in the opposite direction (this is shown by way of example by dashed lines in FIG. 5), in which case the electrical connecting points 200′ are not located on the half-dipole components and are not located at the end of the half-dipole components opposite their outer corner regions 202 but on balanced lines 115, 116, 117, 118, that is to say on the cable halves, which in each case interact in pairs, for one dipole half.

As is shown in FIGS. 6 and 7, this electrical connection or transverse strut 200 need not necessarily run in a straight line. It is also possible for this electrical connection or transverse strut 200 to be formed to be at least slightly convex or concave, for example, in a plan view. The electrical cross connection or transverse strut 200 may likewise be designed and arranged to be at least slightly curved, such that the corresponding connecting section runs at least partially above or below the plane which is formed of half-dipole components.

The vertical cross-sectional illustration transversely with respect to the plane of the reflector 33 as shown in FIG. 8 (and likewise in FIG. 9) shows that the transverse struts or cross connections 200 may also run in a curved shape upwards or downwards from the rest of the plane of the dipole halves (that is to say pointing away from or towards the reflector plate).

FIG. 10 is a schematic plan view to show that a corresponding antenna element arrangement may also have dipole halves which, in plan view, likewise have square or approximately square structures, but in which the dipole surfaces in the inner area are not essentially free and empty but, instead, are in the form of a solid surface.

The transverse strut or cross connection 200 as explained with reference to FIGS. 1 to 9 is formed in the exemplary embodiment shown in FIG. 10 by a flat element 200′, with the boundary edges 115a′ to 118b′ which in each case point towards one another being formed in the exemplary embodiments 1 to 9 by the balancing lines which run symmetrically and preferably parallel to one another. The boundary edges 111a′ to 114b′ which point outwards correspond, in terms of their function, to the half-dipole components 111a to 114b shown in the exemplary embodiments in FIGS. 1 to 9. The opening area 300 in the flat dipole halves 3′ato 3″b are formed in the exemplary embodiments shown in FIGS. 1 to 9 by the corresponding opening area 300 which are [sic] formed by the transverse struts 200 shown there and by the half-dipole components 111a to 113b which in each case point upwards. In the exemplary embodiment shown in FIG. 10, the outer corner region 202 is preferably likewise open, so that the opening 300 is not bounded on the outside by this separation area 202 and, specifically from the electrical point of view, is not bounded such that it is closed. A nonconductive corner element, which is used only for mechanical robustness, may, however, be used, as is shown by dashed lines for the dipole half at the top on the right in plan view shown in FIG. 10.

1. Dual-polarized antenna element arrangement, having the following features:
the antenna element arrangement has two or more dipoles which are arranged and designed, in plan view, in the manner of a dipole square or similar to a dipole square, or with a surrounding structure which is similar to a dipole square in plan view,
each dipole is fed by means of a balanced line,
the antenna element arrangement is interleaved and is fed such that, from the electrical point of view, the antenna element arrangement is equivalent to a cruciform dipole when two mutually perpendicular polarization planes which run parallel to the two mutually perpendicular diagonals which are formed by the antenna element arrangement,
the dipole halves, which from the electrical point of view are equivalent to a cruciform dipole, from the physical design point of view each have two half-dipole components which are arranged such that they run transversely and preferably vertically and/or essentially at right angles to one another and end at a distance from one another in their corner region which is remote from the center of the antenna element arrangement, or are electrically connected to one another, or are mechanically connected to one another using a nonconductive material, in this outer corner regions, characterized by the following further features:
the mutually interacting half-dipole components which, from the electrical point of view, each form one dipole half, are electrically connected to one another not only via their feed point but also via a second connection with respect to this or via a transverse strut, with this second connection or transverse strut acting on the respective half-dipole components, which interact with one another in pairs, directly or indirectly, and offset with respect to the outer corner region.

2. Dual-polarized antenna element arrangement according to claim 1, characterized in that the electrical cross connection or transverse strut is electrically connected to the respectively associated half-dipole component and/or to the respectively associated balanced line (115-118) which is furthest away from the outer corner region.

3. The dual-polarized antenna element arrangement according to claim 1, characterized in that an opening which passes through the plane of the associated dipole half is provided between the cross connection or transverse strut and the outer corner region and the area of this opening corresponds to at least 20% of the total area of the associated dipole half, with the boundary edges which point outwards not being electrically connected to one another in the associated outer corner region.

4. Dual-polarized antenna element arrangement having the following features:
the antenna element arrangement is designed and fed such that, from the electrical point of view, it has two mutually perpendicular polarization planes in the form of a cruciform dipole,
the dipole halves are designed to be flat,
the side boundaries, which each point towards one another, of two adjacent dipole halves are symmetrical and are preferably arranged such that they run parallel to one another, characterized by the following further features:
in a plan view, the dipole halves preferably each have a square structure or outer boundary, or a structure or outer boundary that is similar to a square,
the flat dipole halves have an opening or aperture whose size is at least 20% of the total area of a respective dipole half, and
the outer boundaries, which point outwards and run at an angle, that is to say preferably at least approximately at right angles to one another, of an associated dipole half end at a distance from one another in the outer corner region such that, from the electrical point of view, the opening is open to the outside over the outer corner region.

5. Dual-polarized antenna element arrangement according to claim 4, characterized in that the outer boundaries which point outwards are in the form of half-dipole components

6. Dual-polarized antenna element arrangement according to claim 4, characterized in that the flat sections of the dipole halves form an electrical connection or a transverse strut and are at least indirectly connected to the outer boundaries which point outwards and/or to the half-dipole components which are simulated by them.

7. Dual-polarized antenna element arrangement according to one of claim 1, characterized in that the electrical cross connection or transverse strut is electrically connected to the respectively associated half-dipole component at a point which is linked to the outer corner region such that the electrical connecting point is located between the outer corner region and the opposite end area (204), half-dipole components

8. Dual-polarized antenna element arrangement according to one of claim 1, characterized in that the electrical cross connection is straight.

9. Dual-polarized antenna element arrangement according to one of claim 1, characterized in that the electrical connection is provided with at least one curvature.

10. Dual-polarized antenna element arrangement according to claim 1, characterized in that the electrical connection or transverse strut is provided, in plan view, with at least one concave or convex curvature.

11. Dual-polarized antenna element arrangement according to claim 1, characterized in that the electrical connection or transverse strut lies in the plane in which the half-dipole components are also located.

12. Dual-polarized antenna element arrangement according to claim 1, characterized in that the electrical cross connection or transverse strut runs with at least one curvature such that at least one section of the electrical cross connection or transverse strut is located outside the plane in which the half-dipole components are arranged.

13. Dual-polarized antenna element arrangement according to claim 1, characterized in that all the half-dipole components including the electrical cross connection or transverse strut are integral.
